(19) United States
(12) Patent Application Publication
(10) Pub. No.: US 2004/0070192 A1
(43) Pub. Date: Apr. 15, 2004

(54) Book/clipped container combination

(76) Inventors: Miriam Kelley, Buffalo, NY (US); Scott H. McIlvain, Holland, NY (US); Matthew K. Brown, Sunnyside, NY (US); Nathan F. Hermann, Cincinnati, OH (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/448,593

(22) Filed: May 30, 2003

Related U.S. Application Data
(60) Provisional application No. 60/384,476, filed on May 31, 2002.
(60) Provisional application No. 60/385,259, filed on May 31, 2002.
(60) Provisional application No. 60/385,024, filed on May 31, 2002.

(51) Int. Cl. B42D 1/00

(52) U.S. Cl. 281/21.1

(57) ABSTRACT

A container for releasable attachment to a book having a binding with a plurality of spaced apart openings includes first and second hook members projecting outwardly from a first end of the container. The hook members are spaced apart from one another sufficiently to be received in at least one pair of the plurality of spaced apart openings. The hook members are configured to releasably engage with the binding upon insertion into the at least one pair of openings.

### CROSS REFERENCE TO RELATED APPLICATIONS

This application is related to U.S. Provisional Patent Application No. 60/384,476 filed May 31, 2002 and entitled ∓Spiral Binding Attachment Clip”, U.S. Provisional Patent Application No. 60/385,259 filed May 31, 2002 and entitled ∓Case for Interactive Multi-Sensory Reading System”, and U.S. Provisional Patent Application No. 60/385,024 filed May 31, 2002 and entitled ∓Method for Teaching Linguistics” and claims the earlier filing dates of the related applications, each of which is incorporated herein by reference.

### BACKGROUND OF THE INVENTION

A typical electronic teaching/learning system for reading comprises one or more books, each of which has at least one area of selectable content, and a media receiving unit, or ∓reader”. The media receiving unit has memory with the selectable content stored therein, a sensor for identifying a specific selection made from the selectable content and a reader configured to produce an output based on the stored material in response to the selection. The selectable content can include letters, words, graphics and the like.

Typically, the media receiving unit may have sufficient non-volatile memory to store material for one or two books. If additional books are to be used with the learning system, the material associated with the additional books must be stored on removable non-volatile memory, such as an integrated circuit (∓IC”) chip including Read Only Memory (∓ROM”) that can be inserted in a slot in the base or housing of the media receiving unit and interface with the processor therein. Frequently, the container housing the IC chip becomes separated from the book and is lost. Sometimes children have difficulty in matching appropriate ROMs and books.

Accordingly, an arrangement which can keep a container having an IC chip with ROM having stored therein material that is associated with the content of the book physically associated with the book to prevent separation or loss of the container would be helpful.

### BRIEF SUMMARY OF THE INVENTION

Briefly stated, according to a first aspect of the present invention, a container for releasable attachment to a book having a binding with a plurality of spaced apart openings includes first and second hook members projecting outwardly from a first end of the container. The hook members are spaced apart from one another sufficiently to be received in at least one pair of the plurality of spaced apart openings. The first and second hook members are configured to releasably engage with the binding upon insertion into at least one pair of the spaced openings.

According to a second aspect of the present invention, a multi-page book includes an elongated loop binding defined by a plurality of consecutive, spaced apart loops having spaces therebetween. The binding has first and second ends, a binding axis centered in the loops and a binding diameter defined by a size of the loops in planes perpendicular to the binding axis. An alignment element is located at at least one of the first and second ends of the binding. The alignment element has a maximum dimension perpendicular to the binding axis which is greater than the binding diameter. At least a plurality of pages are rotatably mounted on the binding. Each page is attached along a binding edge to the binding through holes in the page. Each hole is larger than the loop passing through the hole. Each page includes at least a first cut out located proximal to the binding along the binding edge. The first cut out is configured to receive a portion of the alignment element.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a top perspective view of an electronic learning system having a media receiving unit, a container attached thereto and a book associated therewith in accordance with a first preferred embodiment of the present invention;

FIG. 2 is a top perspective view of the container of FIG. 1;

FIG. 3 is an exploded view of the container of FIG. 2;

FIG. 4a is a bottom plan view of the container of FIG. 2;

FIG. 4b is a bottom perspective view of the container of FIG. 2 inserted in a slot in the media receiving unit;

FIGS. 5a and 5b are connector end views of the media receiving unit and container of FIG. 4, respectively;

FIG. 6 is a bottom plan view of a container in accordance with a second preferred embodiment of the present invention;

FIG. 7a is a top perspective view of the container of FIG. 2 attached to the book of FIG. 1 in accordance with a third preferred embodiment of the present invention;

FIG. 7b is a top perspective view of a container attached to the book of FIG. 1 in accordance with a fourth preferred embodiment of the present invention;

FIG. 8 is an exploded view of the book of FIG. 1;

FIG. 9 is a top perspective view of a portion of an alternative embodiment of the spine of the binding of the book in FIG. 8;

FIG. 10 is a top perspective view of an alternative embodiment of the binding of the book in FIG. 8;

FIG. 11 is an enlarged top perspective view of just the spine of the book of FIG. 8 engaged with the media receiving unit of FIG. 1;

FIG. 12 is a top perspective view of an alternative embodiment of the binding of the book of FIG. 8; and

FIG. 13 is an enlarged top perspective view of the binding of FIG. 12.

### DETAILED DESCRIPTION OF THE INVENTION

Certain terminology is used in the following description for convenience only and is not limiting. The words ∓right”, ∓left”, ∓lower” and ∓upper” designate directions in the drawings to which reference is made. The words ∓inwardly” and ∓outwardly” refer to directions toward and away from, respectively, the geometric center of the container and/or book and designated parts thereof. The terminology includes the words above specifically mentioned, derivatives thereof and words of similar import.

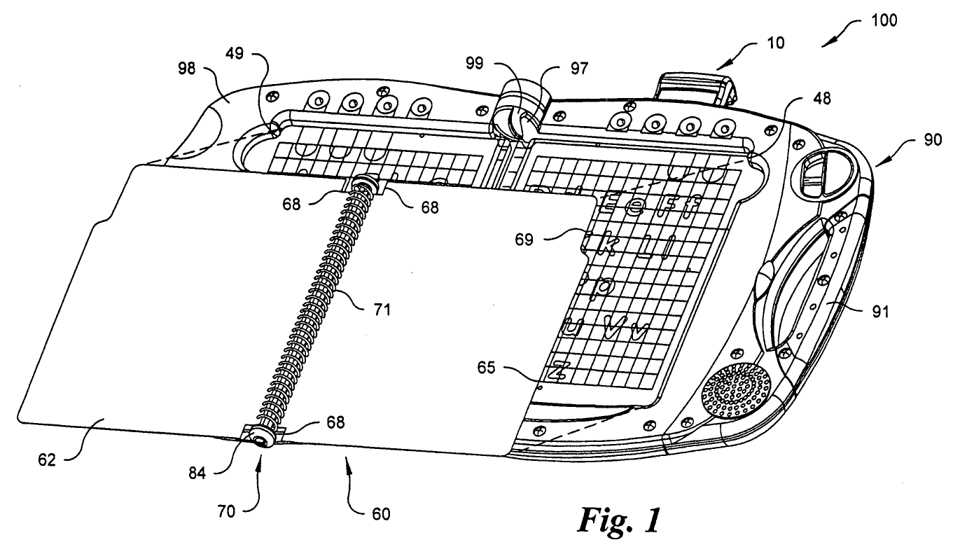

Referring to the drawings in detail, wherein like numerals indicate like elements throughout, there is shown in FIGS. 1-4b and 5b a first preferred embodiment of a container, generally designated 10, in accordance with the present invention. The container 10 houses an IC chip which includes non-volatile memory, such as ROM, for use with an electronic learning system 100, the other components of which are shown in FIG. 1. These include an electronic, media receiving unit 90 and a printed media element, a book 60, used with the media receiving unit 90. The container 10 preferably is configured for releasable attachment to the book 60 and to the media receiving unit 90.

The media receiving unit 90, with which the container 10 and book 60 are preferably used, is the subject of a co-pending U.S. patent application filed by the assignee of the present application. The co-pending application is entitled ∓Electronic Learning Device for an Interactive Multi-Sensory Reading System”, Ser. No. 10/______, (attorney Docket No. 9968-34U1; Express Mail Label Number EV 343987403 US), filed May 30, 2003, and is incorporated herein by reference. Accordingly, only the features of the media receiving unit 90 pertinent to an understanding of the container 10 and book 60 are briefly summarized in this disclosure.

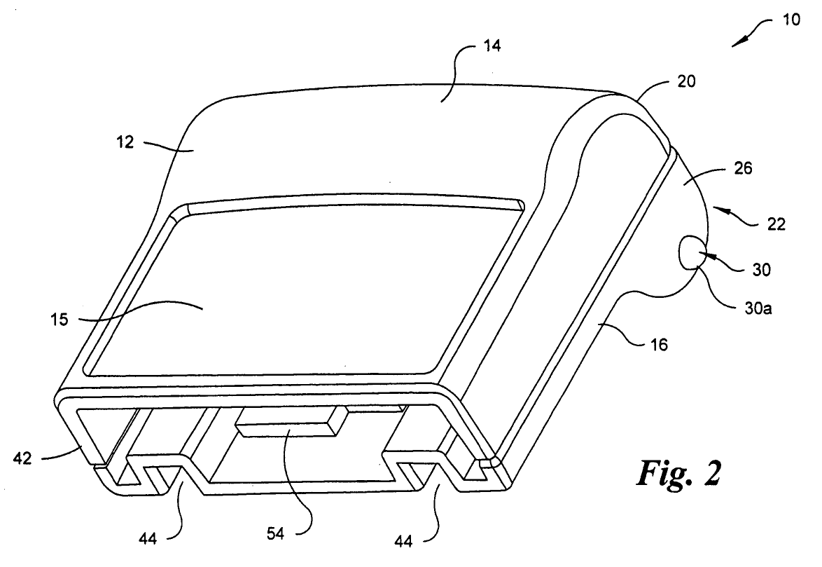

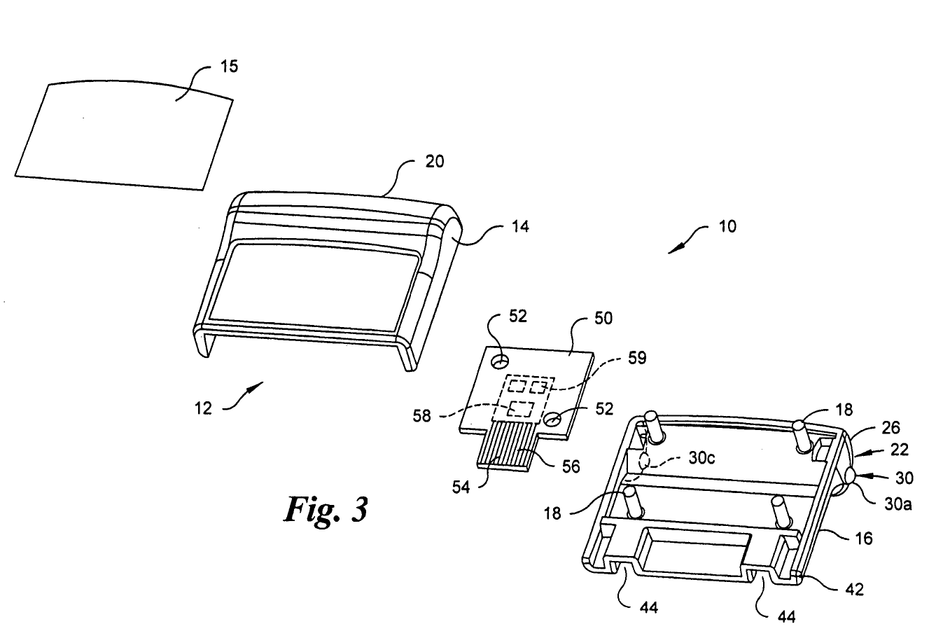

Referring to FIGS. 2-5b, the container 10 includes a housing 12 formed by a first (or upper) shell 14 which is attached to a second (or lower) shell 16. As shown in FIG. 3, the second shell 16 is aligned with the first shell 14 by one or more alignment posts 18 which are received by corresponding alignment recesses (not shown) in the first shell 14. The first and second shells 14, 16 are preferably attached to each other around their respective perimeters by a sonic weld. A label 15 preferably is affixed to the top, exterior of the first shell 14 to designate the particular book 60 with which the contents of the non-volatile memory stored in the container 10 are associated. The housing 12 is preferably made of a hardened plastic, but may be made of other materials generally known in the art, including, for example, soft and/or flexible plastic, without departing from the spirit and scope of the present invention.

A printed circuit board (∓PCB”) 50 resides within the housing 12 between the first and second shells 14, 16. The PCB 50 includes one or more mounting holes 52 therein which are preferably positioned in the PCB 50 to correspondingly align with mounting posts (not shown) on the upper interior portion of the first shell 14. The mounting posts receive the PCB 50, thus aligning and mounting the PCB 50 to the first shell 14. When the first shell 14 is aligned with and placed on top of the second shell 16, the PCB 50 is properly secured and aligned within the housing 12. The PCB 50 includes an IC, generally designated 58 (see FIG. 3), and accompanying electrical components 59 necessary for operation of the PCB 50. The IC 58 includes at least a non-volatile memory, such as ROM, and preferably further includes its own microcontroller.

The PCB 50 preferably includes a connector portion 54 which extends outwardly toward a second end 42 of the container 10 from the interior of the housing 12, where the majority of the PCB 50 containing the IC 58 and the accompanying electronic components 59 are preferably safely contained. The connector portion 54 extends outside of the closed portion of the housing 12 to connect with the media receiving unit 90. The connector portion 54 includes traces 56 thereon for electrical connection of the components on the PCB 50 to corresponding contacts in the media receiving unit 90.

The housing 12 includes first and second hook members 22, 24 which project outwardly from a first end 20 of the container 10. The hook members 22, 24 are preferably spaced apart from one another by the width of the housing 12 at the first end 20. The first hook member 22 is preferably defined by a first end wall 26 which projects outwardly from the first end 20 of the housing 12. The first end wall 26 is preferably formed on the second shell 16 and projects away from the first shell 14. Similarly, the second hook member 24 is preferably defined by a second end wall 28 which projects outwardly from the first end 20 of the housing 12. The second end wall 28 is preferably formed on the second shell 16 on an end of the housing 12 opposite the first end wall 26, and also extends away from the first shell 14. Those skilled in the art will recognize that the first and second end walls 26, 28 may alternatively be formed on the first shell 14 and project away from the second shell 16 without departing from the spirit and scope of the present invention. Additionally, as will become evident from the following discussion, the container 10 may be configured to include only one hook member 22, 24 or more than two hook members 22, 24 without departing from the spirit and scope of the present invention.

The first and second end walls 26, 28 are formed such that the hook members 22, 24 are generally parallel with respect to each other. Additionally, the first and second end walls 26, 28 extend from the second shell 16 such that the hook members 22, 24 are generally in the same plane as the sides of the housing 12. However, those of ordinary skill in the art will recognize that the first and second hook members 22, 24 may project toward one another (i.e., be oriented at an acute angle with respect to the first end 20 of the housing 12), or project away from each other (oriented at an obtuse angle with respect to the first end 20 of the housing 12). Alternatively, the hook members 22, 24 may be parallel to each other, but at the same angle with respect to the first end 20. Different angled projections of the hook members 22, 24 may assist in accommodating the container 10 for releasable attachment to different types or sizes of book bindings.

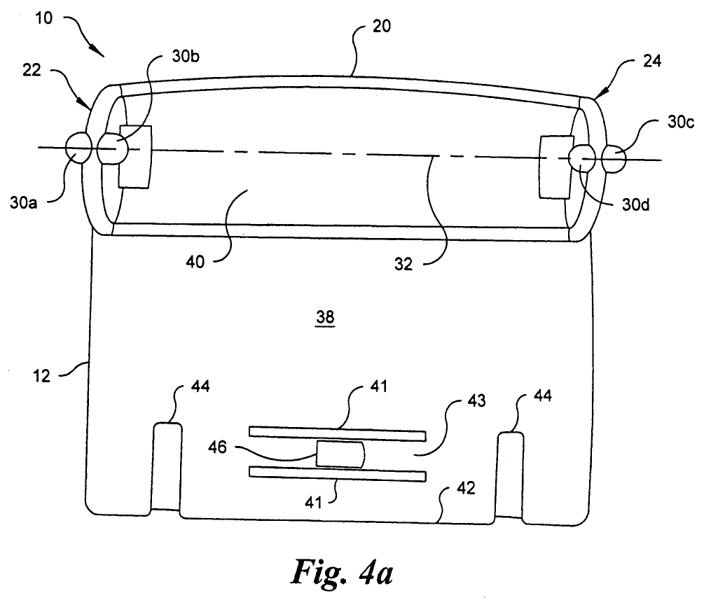

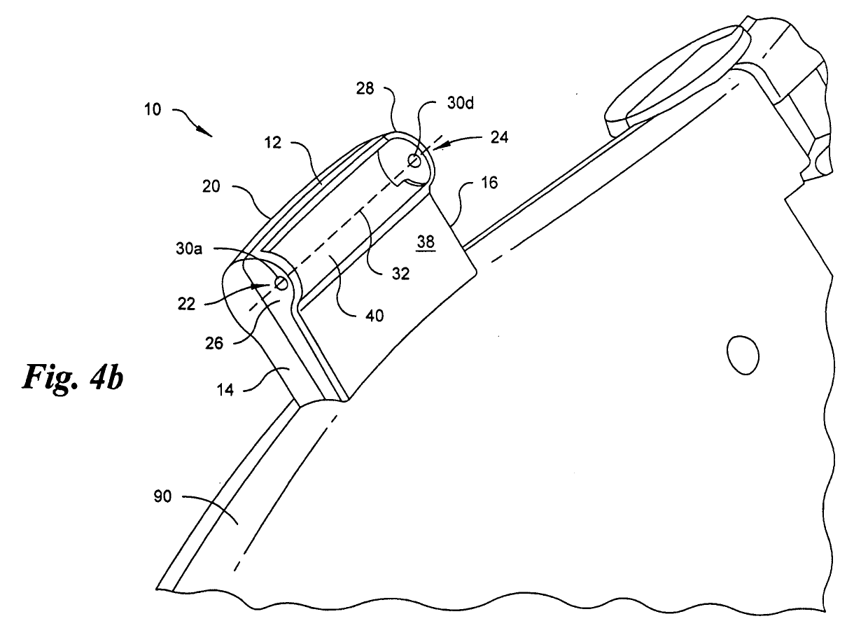

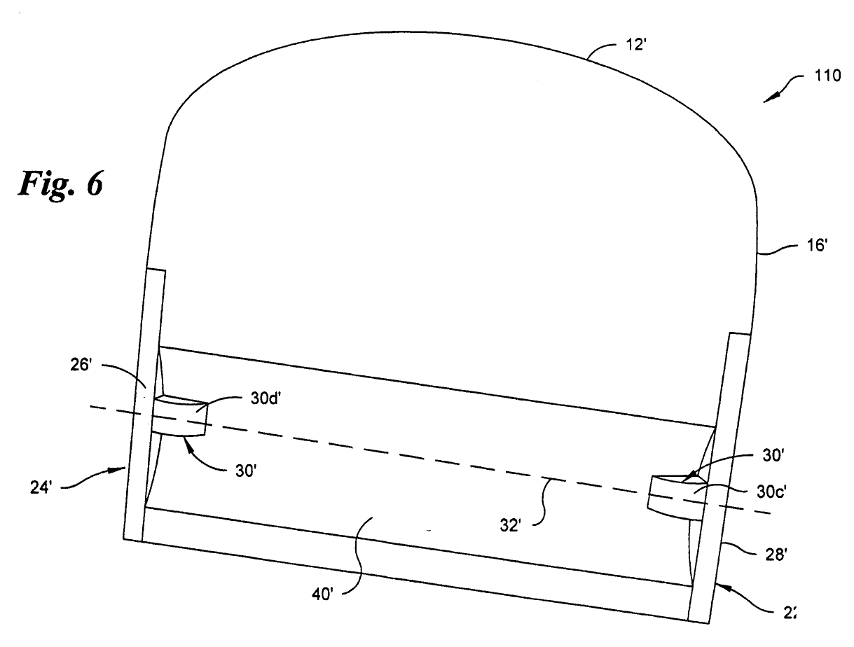

Each of the end walls 26, 28 preferably includes at least one tab, generally designated 30, which extends at least partially transverse from its respective end wall 26, 28. Preferably, a first pair of preferably mirror image tabs 30a, 30b extends outwardly from each of the first and second end walls 26, 28, respectively, and a second pair of preferably mirror image tabs 30c, 30d extends inwardly (i.e., toward the opposite end wall) from the opposing sides of the first and second end walls 26, 28, respectively. Thus, each end wall 26, 28 preferably includes two tabs 30, one extending inwardly and one extending outwardly from each respective side of the end walls 26, 28, generally transverse to that end wall. Preferably, but not necessarily, the first and second pairs of tabs 30a, 30b and 30c, 30d are generally coincident with a longitudinal axis 32 (see FIGS. 4a and 4b). As discussed in greater detail below, the tabs 30 are used to removably attach the container 10 to the binding of a book or the like. Those of ordinary skill in the art will understand from this disclosure that either the first pair of tabs 30a, 30b or the second pair of tabs 30c, 30d or a third pair of tabs formed by a combination of an inwardly extending tab 30d from one end wall 26, 28 and an outwardly extending tab 30a from the other end wall 26, 28 (as shown, for example, in FIG. 4b) or a combination of one pair of tabs 30a, 30b and one or both tabs 30c, 30d of the remaining pair may be used to removably attach the container 10 to the loop binding of a book by inserting the hook members 22, 24 into the spaced openings formed by the binding. For example, in an alternative embodiment shown in FIG. 6, the container 110 includes only a pair of tabs 30c′, 30d′ projecting inwardly towards one another from end walls 26′, 28′.

The tabs 30 are preferably semispherical or dome-shaped projections which extend from the first and second hook members 22, 24 as described above. However, those skilled in the art will recognize that the tabs 30 may have alternate shapes or structures to attach to different types of book bindings or to provide different types of attachment. For example, in an alternative embodiment shown in FIG. 6, the container 110 includes tabs 30′ which have a generally saw-toothed shape, such that a beveled edge of the tabs 30′ initially contacts book binding when attaching the container 110 to the book.

The housing 12 of the container 10 preferably also includes an elongated channel 40 which extends the width of the housing 12. The elongated channel 40 preferably has a generally partial cylindrical shape and is formed by a portion of the outer surface 38 of the second shell 16. The channel 40 is bounded on opposed ends by the first and second end walls 26, 28, respectively. The channel 40 is shaped and sized to receive at least a portion of the binding of the book therein when the hook members 22, 24 of the container 10 are inserted between the spaced openings of the book binding, as discussed in greater detail below. Similar elements in alternate embodiment 110 are marked with the same numerals with an apostrophe.

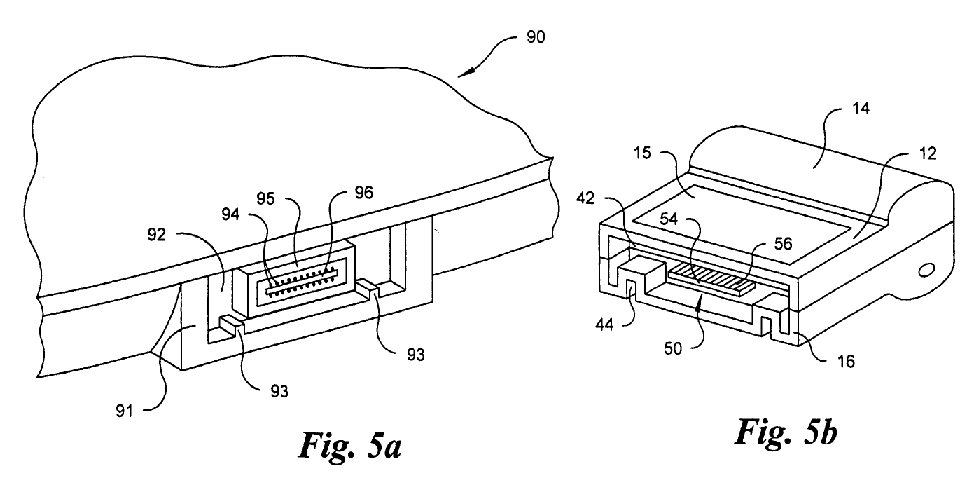

As noted above, the container 10 is designed for releasable attachment to the media receiving unit 90. Referring to FIGS. 1, 2 and 4a-5b, the second end 42 of the housing 12 has a generally rectangular-shaped cross section. The second end 42 is removably insertable in a correspondingly shaped slot 92 in a base 91 of the media receiving unit 90. The portion of the second shell 16 forming the second end 42 has guide ways 44 that cooperate with keys 93 in the slot 92 which permit insertion of the second end 42 into the slot 92 only when the housing 12 is in the correct orientation with respect to the slot 92. The cooperation of the guide ways 44 with the keys 93 helps assure proper connection of the PCB 50 to the connector 95 in the slot 92, and thus to electronics (not shown) within the media receiving unit 90. The cross-sectional shape of the second end 42 of the housing 12 and the corresponding shape of the slot 92 can be any well-known shape for providing an orientation for a specific electrical connection between the PCB 50 and the connector 95 in the base 91. Possible shapes for the cross section of the second end 42, in addition to the rectangular shape shown in FIGS. 2 and 5b, include a circular or square cross-sectional shape or any mateable or geometric shape.

Preferably, the housing 12 includes two slots 41 in the outer surface 38 of the second shell 16 which form a flexible snap tab support 43 near the second end 42 (see FIG. 4a). At least one snap tab 46 projects from the snap tab support 43. The snap tab 46 is configured to mate with a correspondingly shaped tab recess (not shown) in the slot 92 of the media receiving unit 90 to help secure the container 10 in the slot 92. The snap tab support 43 is sufficiently flexible to allow easy engagement and disengagement of the snap tab 46 with the tab recess, while also being of sufficient rigidity to help secure the container 10 in the slot 92 when the snap tab 46 is engaged with the tab recess. Those skilled in the art will recognize that the snap tab support 43 may have multiple snap tabs 46 thereon without departing from the spirit and scope of the present invention. Alternatively, the container 10 may be formed without a snap tab support 43 or a snap tab 46.

When the container 10 is properly oriented with respect to the slot 92 of the media receiving unit 90, as the container 10 is inserted into the slot 92, the connector portion 54 of the PCB 50 is received into the opening 96 in the connector 95, such that each of the traces 56 on the connector portion 54 connects to a corresponding lead 94 on the connector 95. When the connector portion 54 has completely mated with the opening 96 and the leads 94, the snap tab 46 preferably snaps or ∓clicks” into engagement with the corresponding tab recess. Upon engagement, the snap tab 46 makes an audible sound (i.e., clicking) so that the user is able verify that a complete electrical connection between the PCB 50 and the connector 95 has been made. The container 10 is secured within the slot 92 by the frictional contact of the connector portion 54 in the opening 96 and engagement of the snap tab 46 within the tab recess. Upon complete insertion of the container 10 in the slot 92, the traces 56 on the PCB 50 connected to the appropriate corresponding leads 94 on the connector 95 connect the IC 58 and components 59 to the corresponding electronics within the media receiving unit 90. The container 10 (and thus the PCB 50) can be removed from the media receiving unit 90 simply by pulling on the container 10 outwardly away from the base 91.

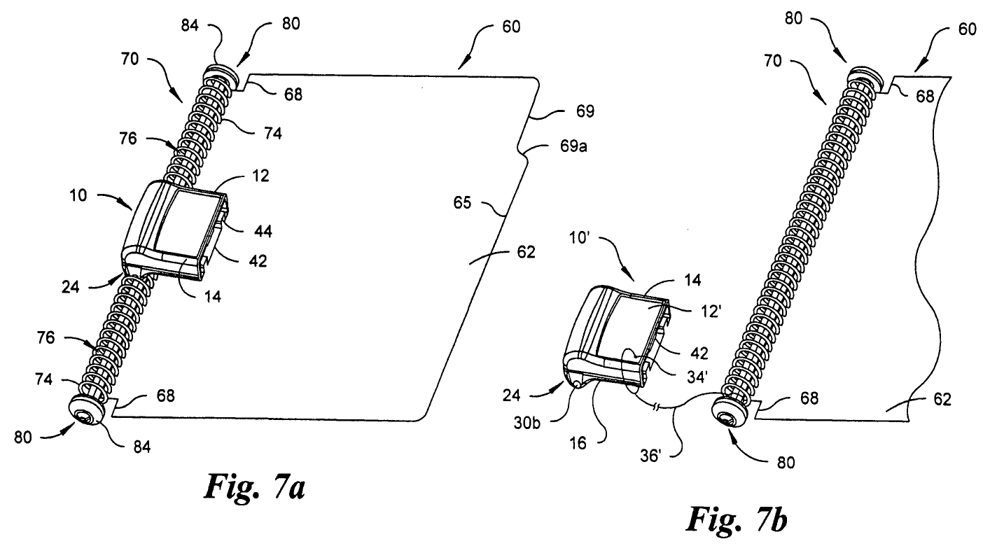

When the container 10 is not attached to the media receiving unit 90, the container 10 may be releasably attached to the book 60, as shown in FIG. 7a. The binding 70 of the book 60 includes spaced openings 76, formed by loops 74 of the binding 70. The hook members 22, 24 of the container 10 are preferably configured to releasably engage with the binding 70 of the book 60 upon insertion of the hook members 22, 24 into at least one of the spaced openings 76.

As discussed above, the hook members 22, 24 are preferably spaced apart from one another approximately the width of the housing 12. The hook members 22, 24 are also spaced from each other such that they may be received in at least one pair of correspondingly spaced openings 76 in the binding 70. That is, when the first hook member 22 is received by a spaced opening 76, the second hook member 24 is preferably automatically aligned with another spaced opening 76 in the binding 70. When the hook members 22, 24 are inserted into the spaced openings 76 of the binding 70, the tabs 30 contact the loops 74 defining the respective spaced opening 76. The corresponding portion of the binding 70 is thus forced away from the tabs 30 and the respective end wall 26, 28, thereby allowing the corresponding hook member 22, 24 to attach the container 10 to the loop binding 70 of the book 60. Preferably, both of the hook members 22, 24 attach to the binding 70 in this manner. However, those skilled in the art will recognize that the container 10 could be attached to the binding 70 of the book 60 by using a different number of hook members 22, 24, depending on the configuration of the container 10 or book 60. For example, if the binding 70 is formed from tighter loops 74, the container 10 may be attached to the binding 70 using only one of the hook members 22, 24. Additionally, since the end walls 26, 28 of the hook members 22, 24 may have a variety of configurations of tabs 30, the number and configuration of tabs 30 on the end walls 26, 28 will determine precisely how and which hook members 22, 24 attach the container 10 to the binding 70.

In an alternative embodiment, as shown in FIG. 7b, the container 10′ may be tethered to the binding 70 of the book 60. The container 10′ includes a hole 34′ in a portion of the housing 12′. A tether 36′ is attached at one end to the binding 70 of the book 60. The opposite end of the tether 36′ is attached to the container 10′ via the hole 34′. The tether 36′ enables the container 10′ to be spaced from the book 60, while still being releasably attached, for alternate types of storage and/or transport. The tether 36′ may be releasably attached to the binding 70, for example, by clipping (not shown) or tying the tether 36′ to the loops 74 or another portion of the binding 70.

As discussed above, the housing 12 of the container 10 may be formed from generally soft and/or flexible material. Accordingly, those skilled in the art will recognize that the container 10 may include a housing 12 which is flexible in combination with at least a portion of the first end 20 which is generally resilient so that the hook members 22, 24 may attach the container 10 to the binding 70 of the book 60 as described above.

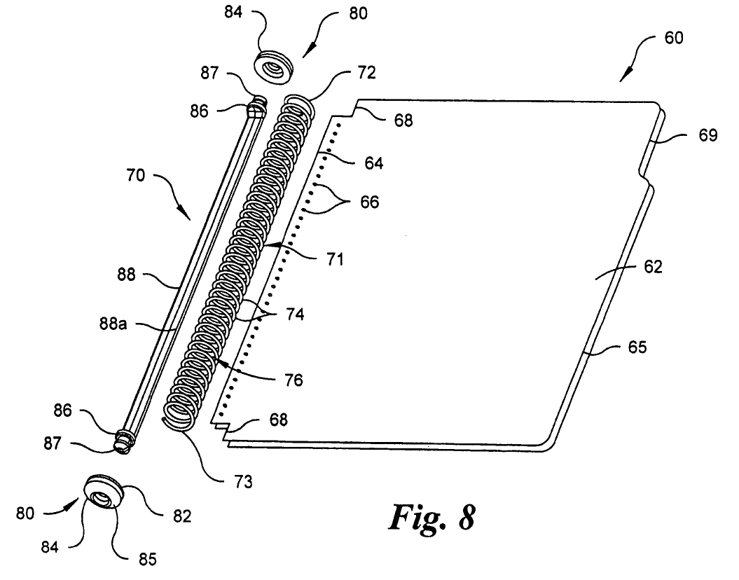

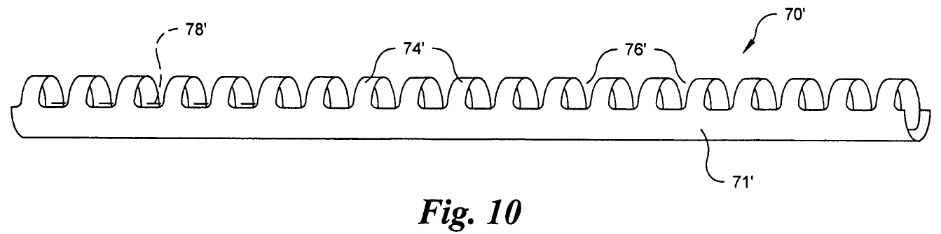

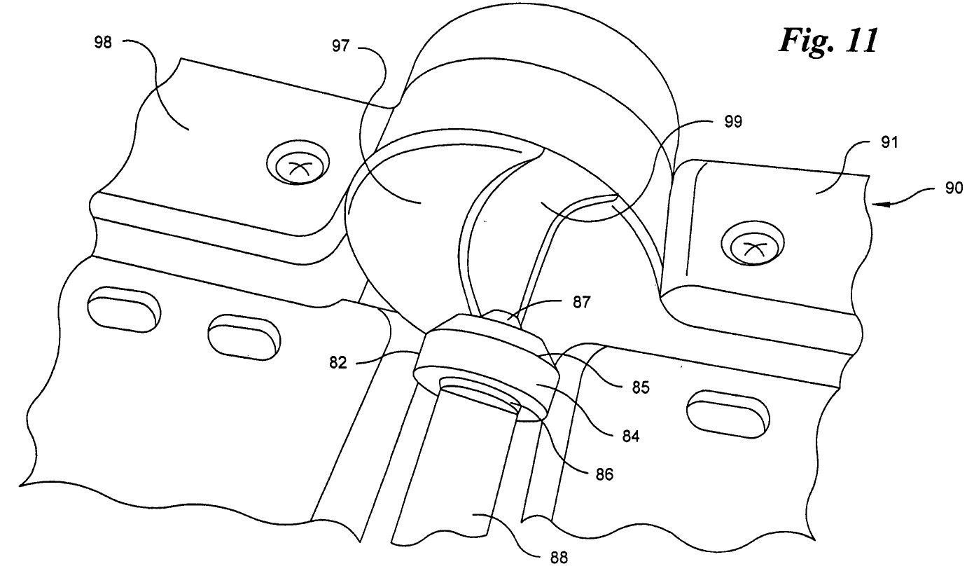

Referring now to FIGS. 7a-13, a book 60 in accordance with the present invention is described in greater detail. The book 60 includes an elongated loop binding 70 having first and second ends 72 and 73, respectively. The binding 70 is defined by a plurality of consecutive, spaced apart loops 74, formed by a resilient cord 71 which is wound generally into a helix shape. Those skilled in the art will recognize that the binding 70 may be formed from any loop-type structure or cord, without departing from the spirit and scope of the present invention. For example, a GBC-spiral 70′, a tubular plastic binding shown in FIG. 10 having one continuous longitudinal edge 71′ supporting a multiplicity of uniformly sized and spaced loop members 74′ which are molded to curve back upon the longitudinal edge 71′ after being passed through openings along the inner edges of the sheets being bound together with the binding 70′ might be used. The shape of the binding 70, 70′ results in a spaced opening 76, 76′ between each consecutive pair of loops 74, 74′. The binding 70, 70′ has a binding axis 78, 78′ which is preferably centered within the loops 74, 74′. The diameter of the looped binding 70 is defined by the size of the loops 74, 74′ as measured in planes which are perpendicular to the binding axis 78, 78′.

The binding 70 preferably further includes an alignment element 80 located at each of the first and second ends 72, 73 of the binding 70. As will later be explained, the alignment elements 80 help align the pages 62 of the book 20 with respect to the binding axis 78, as well as help the user rotate the pages about the loops 74 of the binding 70. The maximum dimension of each alignment element 80, as measured perpendicular to the binding axis 78, is greater than the binding diameter. Those skilled in the art will recognize that other embodiments of the binding 70 may include only a single alignment element 80 at one of the ends 72, 73, multiple alignment elements 80 at each end 72, 73, or a combination thereof, without departing from the spirit and scope of the present invention.

The alignment element 80 preferably has a generally cylindrical portion 82 which has the maximum dimension of the alignment element 80. In a preferred embodiment of the book 60, each alignment element 80 is provided by an end cap 84 which is mounted on a post 86. A post 86 projects from each of the first and second ends 72, 73 of the binding 70, such that there is an end cap 84 at each of the first and second ends 72, 73. The end cap 84 is preferably rotatable about the binding axis 78, and is preferably shaped to have a frustroconical portion 85 distal to the binding 70, while the cylindrical portion 82 is preferably proximal to the binding 70. The end cap 84 may also be formed to be entirely cylindrical, or another shape, so long as the end cap 84 helps provide alignment and rotation of the pages with respect to the binding 70 as will be described. The alignment elements 80 at each of the first and second ends 72, 73 may be formed by elements other than a post 86 and an end cap 84. For example, the alignment element 80, end cap 84 and/or the post 86 may attach to the binding 70 and/or the resilient cord 71 in any manner generally known to those skilled in the art, such as by clipping, snapping or clamping onto the loops 74 or another portion of the resilient cord 71, binding 70 or book 60.

The binding 70 of the book 60 further preferably includes a spine member 88 which is positioned within the loops 74 of the resilient cord 71, and is aligned generally along the binding axis 78. The spine member 88 preferably supports one or both posts 86 at the respective ends 72, 73 of the binding 70, in that the posts 86 are end portions of the one-piece molded spine member 88. The main body 88a of the spine member 88 within the binding 70 has a generally crescent shape in planes perpendicular to the binding axis 78. The crescent shape of the main body 88a adds strength and rigidity along the length of the spine member 88 (i.e., in the direction of the binding axis 78), such that the spine member 88 is prevented from warping from the weight of the spine member 88, the binding 70 and the pages 62.

The book 60 further includes one or more pages 62 which are rotatably mounted on the binding 70. Each page 62 includes a binding edge 64 proximal to the binding 70. Each page 62 further includes one or more holes 66 along the binding edge 64, to receive the loops of the binding, e.g., 70, 70′. Each hole 66 is slightly larger than the loop 74 passing through the hole 66, such that each page 62 is easily bound with the binding and rotatable about the loops 74. In this manner, the pages may be rotated about the binding axis 78 around the loops 74, much like any conventional spiral-bound book.

Each page 62 further includes a first cutout 68 located proximal to the binding 70 along the binding edge 64 of the page 62 at each of the first and second ends 72, 73 of the binding 70. The first cutouts 68 are configured to receive at least a portion of the alignment element 80 which is attached to the binding 70 sufficiently closely to maintain the binding edge 64 of each page 62 at least a set distance away from the binding axis 78. The end caps 84 assure that the pages 62 are biased outwardly from the binding axis 78 at least a predetermined distance (i.e., the radius of the end caps 84) to assure that the pages 62 lie in outward most positions in the media receiving unit 90. Maintaining the binding edge 64 of the pages 62 at least some distance away from the binding axis 78 further enables the pages 62 of the book 60 to be freely rotatable on the loops 74 about the binding axis 78, without interference from the spine member 88, other pages 62 or any other portion of the book 60. Those skilled in the art will recognize that the pages 62 of the book 60 may have any number of cutouts along the binding edge to correspond with the number of alignment elements attached to the binding.

As discussed above, the book 60 is also configured for insertion into and use with the media receiving unit 90. The media receiving unit 90 includes a base 91 and a cover 98 which fold open opposite each other, as shown in FIG. 1. The media receiving unit 90 preferably includes one or more binding mounts 97 located generally in the center of the media receiving unit 90 on the inner side of the hinges joining the base 91 and the cover 98 when the base 91 and cover 98 are folded open.

To support the book 60 and the binding 70 in the media receiving unit 90, the book 60 further includes mounting elements 87 located at each of the first and second ends 72, 73 of the binding 70 of the book 60. The mounting elements 87 are preferably the distal ends of the posts 86 and/or the spine member 88 of the binding 70. The mounting elements 87 are configured such that the binding 70 is releasably received in the binding mounts 97 of the media receiving unit 90 when the book 60 is inserted into the media receiving unit 90 (see FIG. 11). The mounting elements 87 may be formed in the shape of a pin, cylinder, or any other shape suitable for reception by the binding recess 99. As shown in FIGS. 1 and 11, the binding mount 97 of the media receiving unit 90 has a generally curved recess 99 for receiving the mounting element 87. However, those skilled in the art will recognize that the binding mount 97 may have other shapes or configurations for releasably receiving the mounting element 87 therein, depending on the shape of the mounting element 87. Additionally, the book 60 may include only a single mounting element 87 at one of the ends 72, 73 of the binding 70 without departing from the spirit and scope of the present invention.

The book 60 further preferably includes a second cutout 69 on each of the pages 62. The second cutout 69 is located distal to the binding 70 along a second edge 65. The second edge 65 is different from the binding edge 64, and is preferably opposite the binding edge 64, although those skilled in the art will recognize that the second cutout 69 may be located predominantly along another (i.e., upper or lower) edge of the pages 62. Preferably, the second cut out 69 has a transverse lower portion 69a for receiving and complementarily mating with the tip of a user's finger, enabling the pages 62 to be turned more easily. When the book 60 is inserted into the media receiving unit 90, the second cutout 69 of the pages 62 complementarily mates with first alignment projection 48 in the base 91 of the media receiving unit, thereby helping to align the pages 62 of the book 60 within the media receiving unit 90 with the first alignment projection 48 and further for aligning the pages 62 with the alignment element 80 of the binding 70. Additionally, the media receiving unit 90 preferably includes a second alignment projection 49 located on the interior portion of the cover 98 in a position which is generally on the opposite side of the media receiving unit 90 from the first alignment projection 48. Where a spiral binding 70 is used, the second alignment projection 49 is offset transversely with respect to the binding axis 78 from the first alignment projection 48. Thus, when a page 62 is rotated about the binding axis 78, the second cutout 69 on the page 62 aligns and complementarily mates with the second alignment projection 49 on the media receiving unit 90. The second alignment projection 49 need not be offset if not required by the shape of the binding 70.

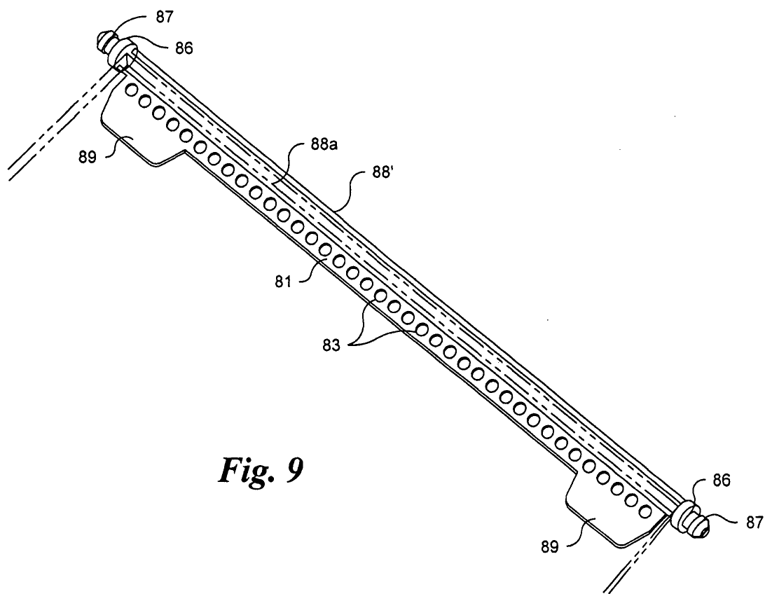

In an alternative embodiment, a spine member 88′ preferably further includes a flange 81 (see FIG. 9) which extends from one side of the spine member 88′. The flange 81 includes a series of holes 83 which receive the loops 74 of the binding 70. The flange 81 further includes tabs 89 which project from the flange 81 near the ends of the binding 70 for helping to assure that the spine member 88′ remains oriented with the open portion of the main body upward. Preferably, the tabs 89 of the flange 81 are attached to the last page 62 of the book 60 by suitable means such as adhesive, such that, so long as the book 60 is in an ∓open” position, the open portion of the main body of the spine member 88′ is oriented upward to provide the proper stability, support and alignment of the pages 62 with respect to the binding 70 and of the book 60 with respect to the media receiving unit 90.

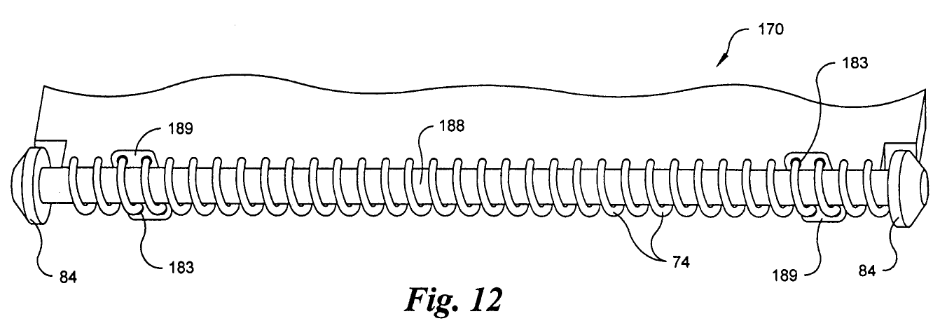

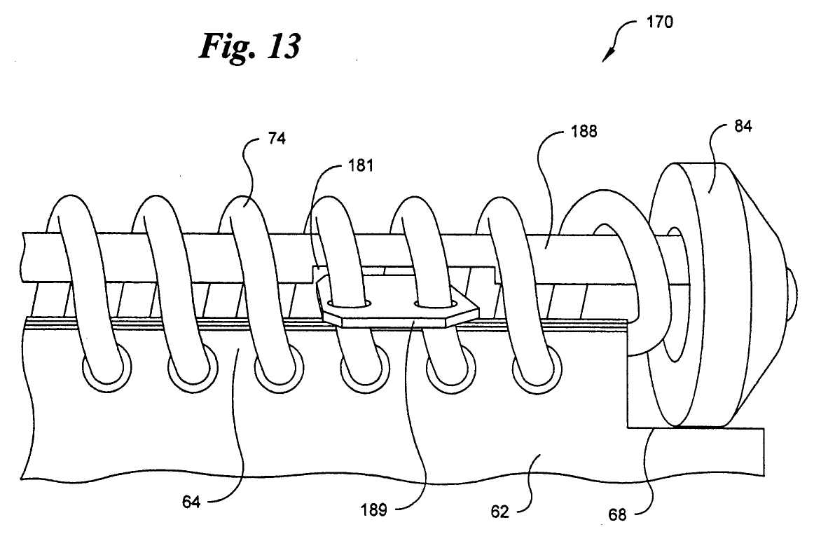

In another alternative embodiment shown in FIGS. 12 and 13, a binding 170 has features similar to those described above with respect to the bindings 70, 70′. However, the binding 170 includes a tab 189 located at each end of the binding 170. The tabs 189 preferably include two pairs of holes 183 configured for mounting the tabs 189 on the loops 74 of the binding 170, such that the tabs 189 are freely rotatable about the loops 74. The tabs 189 preferably have an oval or rectangular shape, and are preferably angled to match the spiral offset of the binding 170. Those skilled in the art will recognize that the tabs 189 may be accordingly shaped to be used with any loop-type binding, such as the binding 70′.

The binding 170 further includes a spine member 188 having features similar to those described above with respect to the spine members 88, 88′. The spine member 188 preferably includes at least one tab notch 181 (see FIG. 13) located near each end of the binding 170. Each tab notch 181 is shaped and sized to receive a tab 189 therein. The tabs 189 are preferably positioned on the loops 74 behind the last page 62 of the book 60, such that the binding edge 64 of the last page 62 (and the first page 62 if the book 60 is in an open position) mates with the tabs 189, biasing the tabs 189 toward their respective tab notches 181. Engagement of the tabs 189 in the tab notches 181 prevents the spine member 188 from twisting or rotating within the loops 74 of the binding 170, thereby maintaining the spine member 188 oriented upward to provide the proper stability, support and alignment of the pages 62 with respect to the binding 70 and of the book 60 with respect to the media receiving unit 90. Those skilled in the art will recognize that the spine member 188 may include any number of tab notches 181 to receive a corresponding number of tabs 189 without departing from the spirit and scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A container for releasable attachment to a book having a binding with a plurality of spaced apart openings, the container comprising:
first and second hook members projecting outwardly from a first end of the container, the hook members being spaced apart from one another sufficiently to be received in at least one pair of the plurality of spaced apart openings and configured to releasably engage with the binding upon insertion into the at least one pair of openings.

2. The container of claim 1 wherein the first and second hook members project towards one another.

3. The container of claim 1 wherein the first end of the container includes an elongate channel extending at least between the first and second hook members and sized and shaped to receive at least a portion of the binding between the at least one pair of the plurality of spaced apart openings.

4. The container of claim 1 being an IC cartridge and further comprising a IC chip within the container and an electrical connector member coupled with the IC chip inside the container, the electrical connector member being exposed at a second end of the container.

5. The container of claim 1 wherein the first and second hook members project away from one another.

6. The container of claim 1 further comprising at least one snap tab at a second end of the container.

7. The container of claim 1 wherein:
the first hook member is defined by a first end wall projecting outwardly from the first end and at least a first tab extending transversely from the first end wall;
the second hook member is defined by a second end wall projecting outwardly from the first end and at least a second tab extending transversely from the second end wall; and
the first and second end walls are spaced apart a distance at least generally coinciding with a distance between the at least one pair of the plurality of spaced openings to receive the first and second end walls.

8. The container of claim 7 wherein the first and second tabs project towards one another.

9. The container of claim 7 wherein the first and second tabs project away from one another.

10. The container of claim 7 further comprising a third tab projecting transversely from the first end wall away from the first tab.

11. The container of claim 10 further comprising a fourth tab projecting transversely from the second end wall away from the second tab.

12. The container of claim 1 wherein the binding has a generally cylindrical shape and is formed by a plurality of spaced apart loops, each of the plurality of spaced apart openings being defined by an adjoining pair of the plurality of loops, and wherein the container includes an elongate channel having a generally partial cylinder shape to receive at least a portion of the binding between the at least one pair of plurality of spaced apart openings.

13. The container of claim 1 wherein the container is in the form of a rigid case.

14. The container of claim 1 in combination with a flexible tether having at least one end secured with the container.

15. The combination of claim 14 in further combination with the book.

16. The combination of claim 15 wherein at least a portion of the tether is attached to the binding of the book.

17. The container of claim 1 in combination with the book.

18. The combination of claim 17 wherein the container and the book are configured for releasable attachment and reattachment of the container to the book at the binding and of the first and second hook members to at least the pair of openings.

19. The combination of claim 18 wherein the first end of the container includes an elongate channel extending at least between the first and second hook members and sized and shaped to receive at least a portion of the binding between the at least one pair of the plurality of spaced openings.

20. The combination of claim 17 wherein:
the binding is defined by a plurality of consecutive, spaced apart loops having spaces therebetween forming the spaced apart openings, the binding having first and second ends, a binding axis and a binding diameter; and
the book further comprises:
an alignment element located at at least one of the first and second ends of the binding, the alignment element having a maximum dimension perpendicular to the binding axis which is greater than the binding diameter; and
at least a plurality of pages rotatably mounted on the binding, each page being attached along a binding edge to the binding through holes in the page, each hole being larger than the loop passing through the hole, each page including at least one proximal cut out located proximal to the binding along the binding edge and configured to receive a portion of the alignment element.

21. The combination of claim 20 wherein reception of the at least one alignment element in the at least one proximal cut out maintains the binding edge of the pages at least a desired distance away from the binding axis.

22. A multi-page book comprising:
an elongated loop binding defined by a plurality of consecutive, spaced apart loops having spaces therebetween, the binding having first and second ends, a binding axis centered in the loops and a binding diameter defined by a size of the loops in planes perpendicular to the binding axis;
an alignment element located at at least one of the first and second ends of the binding, the alignment element having a maximum dimension perpendicular to the binding axis which is greater than the binding diameter; and
at least a plurality of pages rotatably mounted on the binding, each page being attached along a binding edge to the binding through holes in the page, each hole being larger than the loop passing through the hole, each page including at least a first cut out located proximal to the binding along the binding edge and configured to receive a portion of the alignment element.

23. The book of claim 22 wherein the alignment element has a generally cylindrical portion with the maximum dimension.

24. The book of claim 22 wherein the alignment element includes an end cap on a post projecting from the at least one of the first and second ends.

25. The book of claim 24 wherein the end cap is rotatable about the binding axis.

26. The book of claim 24 wherein the end cap has at least a frustroconical portion distal to the binding.

27. The book of claim 24 wherein the end cap has at least a cylindrical portion proximal to the binding.

28. The book of claim 24 wherein the post is supported by a spine member at least partially positioned within the loops of the binding.

29. The book of claim 28 wherein the spine member is attached to a page of the book.

30. The book of claim 28 wherein the spine member has a generally crescent shape in planes perpendicular to the binding axis.

31. The book of claim 28 further comprising at least one tab rotatably mounted on the binding configured for engaging at least one notch on the spine member.

32. The book of claim 22 wherein reception of the at least one alignment element in the first cut out maintains the binding edge of the pages at least a desired distance away from the binding axis.

33. The book of claim 22 wherein the binding is a resilient cord generally wound into a helix shape.

34. The book of claim 22 for use with a print media receiving unit having at least one binding mount, the book further comprising a mounting element projecting from at least one of the first and second ends of the binding.

35. The book of claim 34 wherein the mounting element is configured to be releasably received in the binding mount.

36. The book of claim 34 wherein the pages include at least a second out located distal to the binding along at least a second edge of the page different from the binding edge, the second cut out complementarily mating with a first alignment projection on the media receiving unit for aligning the pages in the unit with the first alignment projection and the alignment element of the binding.

37. The book of claim 36 wherein the second edge is opposite the binding edge.

38. The book of claim 36 wherein the second cut out complementarily mates with a second alignment projection on the media receiving unit when a page is rotated about the binding axis.

39. The book of claim 36 wherein the second cut out includes a generally beveled portion to complementarily receive a user's finger.
